(19) United States
(12) Patent Application Publication
(10) Pub. No.: US 2006/0128925 A1
(43) Pub. Date: Jun. 15, 2006

(54) Pressure sensitive adhesive composition for polarization film

(75) Inventors: Takayuki Arai, Tokyo (JP); Mikihiro Kashio, Saitama-shi (JP); Eiko Kozukue, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: LINTEC CORPORATION, Tokyo (JP)

(21) Appl. No.: 11/193,428

(22) Filed: Aug. 1, 2005

(30) Foreign Application Priority Data
Aug. 23, 2004 (JP) 2004-241863

(51) Int. Cl. C08G 18/00

(52) U.S. Cl. 528/44

(57) ABSTRACT

A pressure sensitive adhesive composition for polarization films used for the front and rear sides of a liquid crystal cell of a system such as IPS (In-Plane Switching), MVA (Multi-Domain Alignment) and the like. The pressure sensitive adhesive composition is made up of: 1) an acrylic copolymer of a (meth)acrylic ester and a monomer having a crosslinkable functional group; and 2) a crosslinking agent; where the storage elasticity of the composition after crosslinking at 0 to 50° C. is in the range of 105 to 109 Pa, and the glass transition temperature (Tg) is −20° C. or higher. The pressure sensitive adhesive composition provides optically functional films imparted with excellent light leakage resistance. Films adhered with the pressure sensitive adhesive composition do not experience floating peeling under conditions of high temperature and high humidity when the composition is used for pasting polarization films by means of crossed Nicols at ∠0 and 90 degrees.

### BACKGROUND OF THE INVENTION

1. Field of the Invention

The present invention relates to a pressure sensitive adhesive composition for polarization films. More particularly, it pertains to a pressure sensitive adhesive composition for polarization films which is used for the front and rear sides of a liquid crystal cell of such a system as IPS (In-Plane Switching), MVA (Multi-Domain Alignment) and the like.

2. Description of the Related Arts

In general, in a conventional liquid crystal cell display system of TN (Twisted Nematic) and STN (Super Twisted Nematic) types, two sheets of transparent electrode substrates constituting an orientation layer are arranged in such a manner that a prescribed interval is maintained via a spacer with the orientation layer being placed in the inside, the periphery of the layer is sealed to form a liquid crystal cell, a liquid crystal material is put in a spacing between the above-mentioned electrode substrates, and further polarization films are made into the form of crossed Nicols at ∠45 and 135 degrees on the outside surfaces of the two sheets of transparent electrode substrates and on the front and rear sides of the liquid crystal cell each via a adhesive layer.

The polarization films that are used in the liquid crystal cell as mentioned above are more liable to cause not only distortion in absorption axes on peripheral portions of the polarization films under the conditions of high temperature and high humidity owing to internal stress generated in the polarization films, but also variation in light transmittance thereby bringing about a light leakage phenomenon.

In order to solve the problem as mentioned above, the light leakage caused by the crossed Nicols at ∠45 and 135 degrees in the liquid crystal cell display system of TN and STN types can be previously suppressed by adding a plasticizer and/or liquid paraffin to a adhesive so as to impart moderate softness and stress relaxation properties (for instance, refer to Patent Literatures No. 1).

However, a adhesive which is used for a liquid crystal cell forming crossed Nicols at ∠0 and 90 degrees for polarization films of IPS and MVA systems that have recently been popularized as the mode corresponding to large-sized liquid crystal TV set and moving images involves a problem in that the light leakage phenomenon can not be suppressed by the method in which stress relaxation properties are imparted to the adhesive as disclosed in Patent Literatures No. 1.

Patent Literature No. 1: Japanese Patent Application Laid-Open No. 137143/1997 (Heisei 9)

### SUMMARY OF THE INVENTION

It is an object of the present invention to provide under such circumstances, a pressure sensitive adhesive composition for polarization films which suppresses light leakage in a liquid crystal cell forming crossed Nicols at ∠0 and 90 degrees for polarization films on the front and rear sides of the liquid crystal cell of IPS and MVA systems, and which has such a highly durable performance as never giving rise to floating peeling of the films even under the conditions of high temperature and high humidity

In order to achieve the above-mentioned objects, intensive extensive research and investigation were accumulated by the present inventors. As a result it has been discovered that the objects can be achieved by setting the storage elasticity of an acrylic copolymer as a pressure sensitive adhesive composition for polarization films after cross linking at a level higher than that of a adhesive being used in the conventional liquid crystal cell system of TN and STN types and at the same time, setting the glass transition temperature of the composition in the specific range so as to harden the same. The present invention has been accomplished by the foregoing findings and information. That is to say, the present invention provides the following.

1. A pressure sensitive adhesive composition for polarization films for use in the case of pasting the polarization films by means of crossed Nicols at ∠0 and 90 degrees to the front and rear sides of a liquid crystal cell which composition comprises an acrylic copolymer (A) of a (meth)acrylic ester and a monomer having a cross linkable functional group in the molecule each as a monomer component and a cross linking agent (B), characterized in that the storage elasticity of the composition after cross linking at 0 to 50° C. is in the range of 105 to 109 Pa, and the glass transition temperature (Tg) thereof is minus 20° C. or higher.

2. The pressure sensitive adhesive composition for polarization films as set forth in the preceding item 1, wherein the glass transition temperature (Tg) thereof is in the range of minus 20 to 30° C.

3. The pressure sensitive adhesive composition for polarization films as set forth in the preceding item 1 or 2, wherein the cross linking agent as the component (B) is a combination system of a polyisocianate compound and a metallic chelate compound.

4. The pressure sensitive adhesive composition for polarization films as set forth in the preceding item 3, wherein the blending ratio by mass of the above-mentioned polyisocianate compound to the metallic chelate compound is in the range of 3:1 to 12:1.

5. The pressure sensitive adhesive composition for polarization films as set forth in any of the preceding items 1 to 4, wherein the blending ratio of the above-mentioned cross-linking agent as the component (B) is in the range of 1 to 5 parts by mass based on 100 parts by mass of the above-mentioned acrylic copolymer as the component (A).

6. The pressure sensitive adhesive composition for polarization films as set forth in any of the preceding items 1 to 5, wherein the acrylic copolymer as the component (A) has a mass-average molecular weight in the range of 300,000 to 1,500,000.

### DESCRIPTION OF THE PREFERRED EMBODIMENTS

The pressure sensitive adhesive composition for polarization films (hereinafter abbreviated to “adhesive composition”) according to the present invention is the adhesive composition which is used for pasting the polarization films by means of crossed Nicols at ∠0 and 90 degrees to the front and rear sides of a liquid crystal cell, and which comprises an acrylic copolymer (A) of a (meth)acrylic ester and a monomer having a cross linkable functional group in the molecule each as a monomer component and a cross linking agent (B), wherein the storage elasticity of the composition after cross linking at 0 to 50° C. is in the range of 10⁵ to 10⁹ Pa, and the glass transition temperature (Tg) thereof is minus 20° C. or higher.

There is used as the above-mentioned acrylic copolymer as the component (A), a copolymer of a (meth)acrylic ester and a monomer having a cross linkable functional group in the molecule each as a monomer component, the copolymer having cross-linking points enabling cross linking by any of various cross linking methods. Such acrylic copolymer having cross-linking points is not specifically limited, but can be optionally selected for use from the (meth)acrylic ester based copolymer that has hitherto been customarily employed as a resin component for adhesive compositions.

The (meth)acrylic ester based copolymer having cross linking points is preferably exemplified by the copolymer of a (meth)acrylic ester wherein an alkyl in an ester moiety has 1 to 20 carbon atoms, a monomer having a cross linkable functional group in the molecule and an other monomer to be used as desired.

Examples of the (meth)acrylic ester wherein an alkyl in an ester moiety has 1 to 20 carbon atoms include methyl (meth)acrylate, ethyl (meth)acrylate, propyl (meth)acrylate, n-butyl (meth)acrylate, isobutyl (meth)acrylate, tert-butyl (meth)acrylate, pentyl (meth)acrylate, hexyl (meth)acrylate, cyclohexyl (meth)acrylate, 2-ethylhexyl (meth)acrylate, isooctyl (meth)acrylate, decyl (meth)acrylate, dodecyl (meth)acrylate, myristyl (meth)acrylate, palmityl (meth)acrylate, stearyl (meth)acrylate and the like. Any of the above-cited (meth)acrylic esters may be used alone or in combination with at least one other species.

On the other hand, examples of the monomer having a cross linkable functional group in the molecule include (meth)acrylic hydroxyalkyl esters such as 2-hydroxylethyl (meth)acrylate, 2-hydroxylpropyl (meth)acrylate, 3-hydroxylpropyl (meth)acrylate, 2-hydroxybutyl (meth)acrylate, 3-hydoxybutyl (meth)acrylate and 4-hydoxybutyl (meth)acrylate; acrylamides such as acrylamide, methacrylamide, N-methylacrylamide, N-methylmethacrylamide, N-methylolacrylamide, N-methylolmethacrylamide; (meth)acrylic acid monoalkyl aminoalkyl such as (meth)acrylic acid monomethyl aminoethyl, (meth)acrylic acid monoethyl aminoethyl, (meth)acrylic acid monomethyl aminopropyl, (meth)acrylic acid monoethyl aminopropyl; and ethylenically unsaturated carboxylic acids such as acrylic acid, methacrylic acid, crotonic acid, maleic acid, itaconic acid and citraconic acid. Any of the above-cited monomers may be used alone or in combination with at least one other species.

Examples of other monomers to be used as desired include vinyl ester such as vinyl acetate and vinyl propionate; olefins such as ethylene. propylene and isobutylene; halogenated olefins such as vinyl chloride and vinylidene chloride; styrenic monomers such as styrene and α-methylstyrene; diolefinic monomers such as butadiene, isoprene and chloroprene; nitorile based momers such as acrylonitrile and methacrylonitrile; and N,N-dialkyl-subatituted acrylamide such as N,N-dimethylacrylamide and N,N-dimethylmethacrylamide. Any of the above-cited monomers may be used alone or in combination with at least one other species.

Examples of initiators to be used for polymerization include azobisisobutyronitrile, benzoyl peroxide, di- tert-butyl peroxide and cumene hydroperoxide.

In the adhesive composition according to the present invention, the polymerization type of the acrylic copolymer to be used as the component (A) is not specifically limited, but may be any of random, block and graft polymerization.

The molecular weight of the acrylic copolymer is in the range of preferably 300,000 to 1,500,000, more preferably 500,000 to 1,200,000 in terms of weight average molecular weight, which is measured by gel permeation chromatography (GPC) and expressed in terms of polystyrene. By setting the weight average molecular weight in the above-mentioned range, it is made possible to assure the adhesiveness to adherend and adhesion durability and suppress floating peeling and the like.

In the acrylic copolymer, the content of the monomer moiety having a cross linkable functional group in the molecule is preferably in the range of 1 to 25% by mass.

By setting the content in the above-mentioned range, it is made possible to assure the adhesiveness to adherend and the degree of cross linking, to keep the storage elasticity of the acrylic copolymer in the range of 10⁵ to 10⁹ Pa after cross linking at every temperature between 0 to 50° C. which is an indispensable requirement of the present invention, and to suppress the light leakage phenomenon in the case of using the adhesive composition for the purpose of pasting polarization films on the front and rear sides of a liquid crystal cell by means of crossed Nicols at ∠0 and 90 degrees against expansion/contraction of the substrate in an atmosphere of high temperature and high humidity. Taking into consideration adhesiveness to adherend and measures against expansion/contraction of the substrate and the like, the content of the monomer moiety having a cross-linkable functional group in the molecule is in the range of more preferably 2 to 20% by mass, particularly preferably 3 to 15% by mass.

The cross linking agent component, which is used as the component (B) and contains at least a bifunctional cross linking agent, is not specifically limited in its type, but may be selected for use from previously customarily employed agents in cross-linking type adhesive composition. The bifunctional cross-linking agent may be properly optionally selected for use, for instance, from the cross-linking agent of polyisocianate compounds, epoxy compounds, metallic chelate compounds, metal alkoxide, metal salts and the like, in accordance with the type of the cross-linkable functional group in the copolymer as the component (A).

As the cross linking agent component containing bifunctional cross linking agent in the present invention, cross linking is carried out by the use of preferably a polyisocyanate compound or a metallic chelate compound, particularly preferably a polyisocyanate compound together with a metallic chelate compound. In the case where a polyisocyanate compound and a metallic chelate compound are simultaneously used, the blending ratio of the polyisocyanate compound to the metallic chelate compound is preferably in the range of 3:1 to 12:1 by mass.

Examples of the polyisocyanate compounds include aromatic polyisocyanate such as tolylenediisocyanate, diphenylmethanediisocyanate and xylylenediisocyanate; aliphatic polyisocyanate such as hexamethylenediisocyanate; and alicyclicpolyisocyanate such as isophoronediisocyanate and hydrogenated diphenylmethanediisocyanate.

Examples of the metallic chelate compounds include aluminum chelate compounds such as aluminum isopropylate, aluminum-sec-butylate and aluminum-acethylacetonate; and metallic chelate compounds such as tetraisobutyl titanate and tetrakis(2-ethylhexoxy) titanate.

Taking into consideration adhesiveness to adherend and assuring storage elasticity enabling favorable durability to be maintained and the like, the cross linking agent component as the component (B) is used in an amount of usually 1 to 5 parts by mass, preferably 1.5 to 3.5 parts by mass based on 100 part by mass of the acrylic copolymer as the component (A).

By blending the acrylic copolymer as the component (A) and the cross linking agent component as the component (B) in an amount as detailed above, and conducting cross linking, it is made possible to achieve the storage elasticity in the range of 10⁵ to 10⁹ Pa at any temperature between 0 to 50° C. and the glass transition temperature of minus 20° C. or higher which are indispensable requirements of the adhesive composition according to the present invention.

The upper limit of the glass transition temperature (Tg) thereof is not specifically limited, but is preferably around 30° C., since unreasonably high Tg brings about lowered adhesiveness to adherend.

The Tg of the acrylic copolymer varies depending upon the polymerization ratio of the monomers to be used for the formation of the copolymer, and is greatly influenced by the Tg of the polymer derived from each of the monomers. In order to achieve the Tg of the component (A) being minus 20° C. or higher, preferably in the range of minus 20 to 30° C., the type and the polymerization ratio of each of the monomers should be properly selected.

The adhesive composition according to the present invention may be incorporated as desired with any of well known additives that have heretofore been used in the adhesive composition to the extent that the objects of the present invention are not impaired thereby. The additives are exemplified, for instance, by plasticizers, tackifying agents, silane coupling agents, ultraviolet absorber, antioxidant and the like. Adding silane coupling agent among the above-exemplified additives to the adhesive composition leads to enhancement of high adhesiveness to liquid crystal cells (glass) under hot humid conditions, thereby making polarization films less liable to floating peeling. Preferable and suitable silane coupling agent is an organosilicon compound which bears at least one alkoxysilyl group in the molecule, and which has favorable miscibility with adhesive components and light transmittance, for instance, substantially transparent substance. The amount of the above-mentioned silane coupling agent to be added is in the range of 0.1 to 1 part by mass based on 100 parts by mass of the adhesive composition expressed in terms of solid content.

The adhesive composition according to the present invention is used for pasting polarization films to the front and rear sides of a liquid crystal cell by means of crossed Nicols at ∠0 and 90 degrees via an adhesive layer derived from the adhesive composition. The adhesive layer may be formed by directly applying the adhesive composition as a coating to both sides or either side of the polarization films. Alternatively the layer may be formed by applying the adhesive composition as a coating to a release treated surface of a release liner which has been release treated, and superposing the release liner thus coated to both sides or either side of the polarization films.

The adhesive composition to be applied (hereinafter abbreviated to “coating solution”) may be any of organic solvent base, emulsion base and solventless base.

Examples of organic solvents to be used for the coating solution include, for instance. toluene, xylene, methanol, ethanol, isobutanol, n-butanol, acetone, methyl ethyl ketone, ethyl acetate and tetrahydrofuran. Any of the above-cited solvent may be used alone or in combination with at least one other species.

The coating solution is preferably prepared for the sake of coating convenience so that the solid concentration falls within the range of 10 to 50% by mass using an organic solvent.

The coating of the coating solution can be carried out by previously well-known coating method such as bar coat method, roll coat method, roll-knife coat method, knife coat method, die coat method, gravure coat method, air doctor coat method and doctor blade coat method. Desirable adhesive layer is formed by subjecting the resultant coating to a during treatment for 1 to 5 minute usually at a temperature in the range of 70 to 110° C. after the coating.

The thickness of the resultant adhesive layer is in the range of usually preferably 5 to 150 μm, particularly preferably 10 to 100 μm.

The adhesive layer thus formed is imparted with storage elasticity in the range of 10⁵ to 10⁹ Pa at any temperature between 0 to 50° C., and glass transition temperature (Tg) of minus 20° C. or higher, preferably minus 20 to 30° C.

The above-mentioned polarization film to be used is that usually formed by a method in which a transparent high molecular film is uniaxially stretched and orientated, iodine and/or a dichroic dye or the like is adsorbed and orientated in the clearance among the orientated molecules, and the resultant polarization film is covered on both the sides with protective films. A polyvinyl alcohol film is presently used for almost all the transparent high molecular films, while a triacetyl cellulose film is prevailingly used for the protective films.

As the polarization film, there are sometimes used an iodine base polarization film, dye base polarization film, colored polarization film, polyvinylene base polarization film, infrared polarization film, ultraviolet polarization film and the like polarization film. Any of the above-cited polarization films is usable in the present invention without specific limitation.

In the present invention, the polarization film which is prepared in such a manner and to which the pressure sensitive adhesive layer is attached is also used for pasting to the front and rear sides of IPS, MVA and the like system by means of crosses Nicols at ∠0 and 90 degrees via the foregoing pressure sensitive adhesive layer.

In summarizing the working effects of the present invention, the pressure sensitive adhesive composition for polarization films according thereto is capable of providing optically functional films which are imparted with highly durable performance and excellent performance of preventing light leakage, and which are free from the occurrence of floating peeling thereof or the like even under high temperature and high humidity.

In what follows, the present invention will be described in more detail with reference to comparative examples and working examples, which however shall never limit the present invention thereto.

### EXAMPLE 1

Into 200 parts by mass of ethyl acetate were added 77 parts by mass of n-butyl acrylate, 20 parts by mass of methyl acrylate, 3 parts by mass of acrylic acid and 0.3 part by mass of azobisisobutyronitrile as a polymerization initiator with stirring at 65° C. for 17 hours, so that acrylic ester copolymer having weight average molecular weight of 800,000 was obtained. To 100 parts by mass of the resultant copolymer were added 2.0 parts by mass of cross linking agent composed of a tolylenediisocianate based polyisocianate compound (manufactured by Nippon Polyurethane Industry Co., Ltd. under the trade name: Colonate L), 0.5 part by mass of cross linking agent composed of an aluminum chelate compound (manufactured by Kawaken Fine Chemical, Co., Ltd. under the trade name: ALCH-TR) and 0.5 part by mass of a silane coupling agent (manufactured by Shin-Etsu Chemical Co., Ltd. under the trade name: KBM-403), while diluting the resultant mixture with toluene so as to obtain a solution of about 20% by mass.

### EXAMPLE 2

Into 200 parts by mass of ethyl acetate were added 90 parts by mass of n-butyl acrylate, 10 parts by mass of acrylic acid and 0.3 part by mass of azobisisobutyronitrile as a polymerization initiator with stirring at 65° C. for 17 hours, so that acrylic ester copolymer having weight average molecular weight of 600,000 was obtained. To 100 parts by mass of the resultant copolymer were added 2.0 parts by mass of cross-linking agent composed of a tolylenediisocyanate based polyisocyanate compound (manufactured by Nippon Polyurethane Industry Co., Ltd. under the trade name: Colonate L) and 0.3 part by mass of a silane coupling agent (manufactured by Shin-Etsu Chemical Co., Ltd. under the trade name: KBM-403), while diluting the resultant mixture with toluene so as to obtain a solution of about 20% by mass.

### EXAMPLE 3

Into 200 parts by mass of ethyl acetate were added 80 parts by mass of n-butyl acrylate, 20 parts by mass of acrylic acid and 0.3 part by mass of azobisisobutyronitrile as a polymerization initiator with stirring at 65° C. for 17 hours, so that acrylic ester copolymer having weight average molecular weight of 500,000 was obtained. To 100 parts by mass of the resultant copolymer were added 2.0 parts by mass of cross linking agent composed of a tolylenediisocyanate based polyisocyanate compound (manufactured by Nippon Polyurethane Industry Co., Ltd. under the trade name: Colonate L) and 0.3 part by mass of a silane coupling agent (manufactured by Shin-Etsu Chemical Co., Ltd. under the trade name: KBM-403), while diluting the resultant mixture with toluene so as to obtain a solution of about 20% by mass.

### EXAMPLE 4

Into 200 parts by mass of ethyl acetate were added 75 parts by mass of n-butyl acrylate, 20 parts by mass of methyl acrylate, 4 parts by mass of acrylic acid, 1 part by mass of 4-hydroxybutyl acrylate and 0.2 part by mass of azobisisobutyronitrile as a polymerization initiator with stirring at 65° C. for 17 hours, so that acrylic ester copolymer having weight average molecular weight of 800,000 was obtained. To 100 parts by mass of the resultant copolymer were added 2.0 parts by mass of cross-linking agent composed of a tolylenediisocyanate based polyisocyanate compound (manufactured by Nippon Polyurethane Industry Co., Ltd. under the trade name: Colonate L), 0.5 part by mass of cross-linking agent composed of an aluminum chelate compound (manufactured by Kawaken Fine Chemical, Co., Ltd. under the trade name: ALCH-TR) and 0.5 part by mass of a silane coupling agent (manufactured by Shin-Etsu Chemical Co., Ltd. under the trade name: KBM-403), while diluting the resultant mixture with toluene so as to obtain a solution of about 20% by mass.

### COMPARATIVE EXAMPLE 1

Into 200 parts by mass of ethyl acetate were added 99 parts by mass of n-butyl acrylate, 1 part by mass of 4-hydroxybutyl acrylate and 0.2 part by mass of azobisisobutyronitrile as a polymerization initiator with stirring at 65° C. for 17 hours, so that acrylic ester copolymer having weight average molecular weight of 1,500,000 was obtained. To 100 parts by mass of the resultant copolymer were added 0.2 part by mass of cross-linking agent composed of a xylenediisocyanate based polyisocyanate compound (manufactured by Mitsui Takeda Chemicals, Inc. under the trade name: Takenate D-110N) and 0.5 part by mass of a silane coupling agent (manufactured by Shin-Etsu Chemical Industries Co., Ltd. under the trade name: KBM-403), while diluting the resultant mixture with toluene so as to obtain a solution of about 20% by mass.

### COMPARATIVE EXAMPLE 2

Into 200 parts by mass of ethyl acetate were added 86 parts by mass of n-butyl acrylate, 10 parts by mass of methyl acrylate, 4 parts by mass of acrylic acid and 0.2 part by mass of azobisisobutyronitrile as a polymerization initiator with stirring at 65° C. for 17 hours, so that acrylic ester copolymer having weight average molecular weight of 1,500,000 was obtained. To 100 parts by mass of the resultant copolymer were added 2.0 parts by mass of cross-linking agent composed of a tolylenediisocylanate based polyisocylanate compound (manufactured by Nippon Polyurethane Industry Co., Ltd. under the trade name: Colonate L) and 0.3 part by mass of a silane coupling agent (manufactured by Shin-Etsu Chemical Co., Ltd. under the trade name: KBM-403), while diluting the resultant mixture with toluene so as to obtain a solution of about 20% by mass.

The coating solutions which had been prepared in Examples 1 to 4 and Comparative Examples 1 to 2 were each applied with knife coat method to the releasingly treated face of each of releasing liners (manufactured by Lintec Corporation. under the trade name: SP-PET3811), the coated releasing liners was each dried at 90° C. for 1 minute to prepare polarization films, which were subsequently laminated to obtain polarization films with pressure sensitive adhesive layers attached having a total thickness of 25 μm each.

Measurements were made of peak and bottom values of storage elasticity (0 to 50° C.), glass transition temperature (Tg), durability and lightness difference ΔL* according to the procedures as described hereunder for the polarization films with pressure sensitive adhesive layers attached that had been obtained in Examples 1 to 4 and Comparative Examples 1 to 2. The results are given in Table l.

(1) Storage Elasticity and Glass Transition Temperature (Tg)

Storage elasticity was measured for each of the samples which had about 3.0 mm thickness and which were prepared by laminating adhesive layers each with 50 ppm thickness using a treatment device of parallel plate with 7.9 mm diameter at a frequency of 1 Hz by the use of a dynamic visocoelasticity measuring apparatus [RDAII] manufactured by Rheometric Scientific.

Glass transition temperature (Tg) of each of the samples was regarded as the temperature at which tan δ (ratio of loss elasticity to storage elasticity) becomes peak.

(2) Durability

Durability was obtained by a method in which the polarization films with pressure sensitive adhesive layers attached measuring 15 inches (233 mm by 309 mm) from which releasing liners were peeled off were each pasted to glass plates, and dried at 80° C. or allowed to stand under the environmental conditions of 60° C. and 90% RH for 500 hours. Thereafter by visually observing the appearances of the films, evaluations were made on the basis of the following criterion.

◯: no floating peeling observed X: floating peeling observed

(3) Lightness Difference ΔL*

Lightness difference ΔL* in the case of crossed Nicols at ∠0 and 90 degrees.

Lightness difference ΔL* was obtained by a method in which the polarization sheets with pressure sensitive adhesive layers attached measuring 15 inches (233 mm by 309 mm) from which releasing sheets were peeled off were each pasted in the case of crossed Nicols to both sides of alkaliless glass plates, and allowed to stand under the environmental conditions of 80° C. drying for 500 hours, thereafter measurements were made of lightness (L1) within the range of 1 cm from 4 corners where each of sides on the peripheral portion crosses at right angles and also of lightness at the center, and ΔL* was obtained from the difference between the average value of the lightness (L1) as measured above and the lightness at the center of the polarization sheets, wherein the lightness was measured under the conditions of 23° C. 65% RH by the use of a measuring apparatus [(MCPD-2000)] manufactured by Otsuka Electronics Co., Ltd.

The results means that the correspondence of the adhesive layer deteriorates with an increase in lightness difference ΔL*.

TABLE 1

| | | | | Durability | | Lightness difference |
|---|---|---|---|---|---|---|
| | Storage elasticity | | | (500 hr) | | ΔL*(80° C. 500 h) |
| | Pa (0 to 50° C.) | | Glass transition | | 60° C./ | ∠0, 90 degrees |
| | peak | bottom | Temp. Tg (° C.) | 80° C. | 90% RH | crossed Nicols |
| Ex 1 | 5.7 × 10⁵ | 1.3 × 10⁵ | −15 | ◯ | ◯ | 0.0 |
| Ex 2 | 2.0 × 10⁶ | 1.8 × 10⁵ | −8 | ◯ | ◯ | 0.1 |
| Ex 3 | 4.5 × 10⁸ | 4.1 × 10⁵ | 22 | ◯ | ◯ | 0.1 |
| Ex 4 | 5.5 × 10⁵ | 1.3 × 10⁵ | −16 | ◯ | ◯ | 0.0 |
| Comp/ | 1.3 × 10⁵ | 9.7 × 10⁴ | −38 | ◯ | ◯ | 1.2 |
| Ex 1 | | | | | | |
| Comp/ | 1.5 × 10⁵ | 6.0 × 10⁴ | −22 | X | X | 1.1 |
| Ex 2 | | | | | | |

{Remarks}
Ex: Example,
Comp/Example: Comparative Example

It is understandable from the results of the lightness difference ΔL* that the pressure sensitive adhesive composition for polarization films according thereto is capable of providing optically functional films which are imparted with very excellent light leakage resistance without the occurrence floating peeling of films under the condition of high temperature and high humidity, when used for pasting polarization films by means of crossed Nicols at ∠0 and 90 degrees.

1. A pressure sensitive adhesive composition for polarization films for use in the case of pasting the polarization films by means of crossed Nicols at ∠0 and 90 degrees to the front and rear sides of a liquid crystal cell which composition comprises an acrylic copolymer (A) of a (meth) acrylic ester and a monomer having a crosslinkable functional group in the molecule each as a monomer component and a crosslinking agent (B), characterized in that the storage elasticity of the composition after crosslinking at 0 to 50° C. is in the range of 10⁵ to 10⁹ Pa, and the glass transition temperature (Tg) thereof is minus 20° C. or higher.

2. The pressure sensitive adhesive composition for polarization films according to claim 1, wherein the glass transition temperature (Tg) thereof is in the range of minus 20 to 30° C.

3. The pressure sensitive adhesive composition for polarization films according to claim 1 or 2, wherein the crosslinking agent as the component (B) is a combination system of a polyisocianate compound and a metallic chelate compound.

4. The pressure sensitive adhesive composition for polarization films according to claim 3, wherein the blending ratio by mass of the above-mentioned polyisocianate compound to the metallic chelate compound is in the range of 3:1 to 12:1.

5. The pressure sensitive adhesive composition for polarization films according to claim 1 or 2, wherein the blending ratio of the above-mentioned crosslinking agent as the component (B) is in the range of 1 to 5 parts by mass based on 100 parts by mass of the above-mentioned acrylic copolymer as the component (A).

6. The pressure sensitive adhesive composition for polarization films according to claim 1 or 2, wherein the acrylic copolymer as the component (A) has a weight average molecular weight in the range of 300,000 to 1,500,000.
